(19) United States
(12) Patent Application Publication
(10) Pub. No.: US 2011/0318209 A1
(43) Pub. Date: Dec. 29, 2011

(54) Fluid-flow system, device and method

(75) Inventors: Philip Allard, San Angelo, TX (US); Stanley D. Benham, Gardendale, TX (US)

(73) Assignee: BLUE MARBLE ENGINEERING LLC, San Angelo, TX (US)

(21) Appl. No.: 13/227,150

(22) Filed: Sep. 7, 2011

Related U.S. Application Data
(63) Continuation of application No. 11/914,901, filed on Nov. 19, 2007, now abandoned.
Application No. 11/914,901 is a continuation-in-part of application No. 11/167,673, filed on Jun. 27, 2005, now Pat. No. 7,597,145.
(60) Provisional application No. 60/716,031, filed on Sep. 9, 2005.
(60) Provisional application No. 60/682,291, filed on May 18, 2005.
(60) Provisional application No. 60/682,291, filed on May 18, 2005.

(51) Int. Cl. F04C 15/00; F01C 1/08; F03B 3/12; F17D 1/00; G05D 11/00

(52) U.S. Cl. 418/1; 137/7; 137/98; 137/99; 416/223 R; 418/196; 418/191

(57) ABSTRACT

Methods, devices, and systems are disclosed for combining fluids of different pressures and flow rates in, for example, gas gathering systems, gas wells, and other areas in which independently powered compressors are not desired. Methods, devices, and systems for turning a shaft are also provided, as are methods, devices, and systems for dropping pressure in a gas line.

### RELATED APPLICATION DATA

This application is the continuation of U.S. National Stage application Ser. No. 11/914,901, filed Nov. 19, 2007, which claims the benefit of International Application No. PCT/US2006/019000, filed May 17, 2006, which claims the benefit of U.S. patent application Ser. No. 11/167,673, filed Jun. 27, 2005, and the benefit of U.S. Provisional Patent Application 60/682,291, filed May 18, 2005, and the benefit of U.S. Provisional Patent Application No. 60/716,031, filed Sep. 9, 2005. U.S. patent application Ser. No. 11/167,673, filed Jun. 27, 2005 further claims the benefit of U.S. Provisional Patent Application 60/682,291, filed May 18, 2005.

### BACKGROUND

In many areas involving fluid-flow, it is desirable to combine two streams of fluid that have different pressures. An example of such a system is a well that produces natural gas.

The gas that comes from a flowing well is typically passed through a separator where liquids “drop out” of the gas stream. Those liquids are very valuable; they contain a high BTU content. The liquids are removed from the separator and placed in a large liquid storage tank, and the remaining gas is removed from the separator in a gas line. The liquid storage tank generates vapor that is slightly above atmospheric pressure. That vapor must be compressed to a pressure closer to the gas leaving the separator (which is expensive) or that vapor must be vented to the atmosphere. In some cases, the volume of vapor is sufficient that a flare can be used; however, flaring of the vapor usually results in incomplete combustion and undesirable by-products, and that results in pollution. It is also a waste of the energy content of the vapor.

Therefore, there is a need for a method, system, and device, which can take fluid of a first pressure (for example, high pressure gas coming from a separator) and combine into that first-pressure-fluid a second fluid of lower pressure (for example, the vapor from a liquid storage tank) while avoiding the normal costs of compression of the second, lower pressure gas.

In some other examples, there are multiple wells in an oil and/or gas producing field. Those wells may be producing gas at differing pressures. To put those multiple wells (each producing at a different pressure) on an individual gas transmission line requires pressure release from the higher pressure flows or compression of the lower line pressure flows. Again, the cost of compression is high; either an electric or gas-fired engine driven compressor is needed. Whether the cost is in lost gas, the cost of electricity, or the cost of the fuel needed to run the compressor, it is undesirable. Therefore, there is a need to combine flows of fluids having different pressures into an individual fluid flow line without the traditional compression steps.

In many areas involving the consumption of natural gas by an end-user, the pressure at which the gas is delivered to the consumer is considerably higher than what is required by the consumer. An example of such a system is a natural gas fired power plant.

The gas that is delivered to a power plant for use a its primary fuel has traveled many miles through a high pressure transmission pipeline network in which the gas has been compressed repeatedly at various intervals along the network. This compression is also referred to as “Booster Stations” along the pipeline network that requires thousands of horsepower using a corresponding amount of fuel gas. The natural gas is transported as far as the market dictates, commonly hundreds of miles and sometimes thousands of miles until it reaches its final destination. The gas is delivered to the commercial end-user at the same pressure at which it was transported (the higher the pressure the more efficient use of the pipeline capacity). The commercial end-user, however, does not require the high pressure for its use. As a result, before the commercial end-user can consume the gas for its processes, it must reduce the gas supply pressure by use of a pressure-reducing valve. This reduction of pressure causes the energy stored in the pipeline to be lost in the form of heat to the atmosphere.

Therefore, there is a need for a method, system, and device, which can reduce the pressure of the natural gas supply to the requirements of the commercial end-user and use the energy (pressure) stored in the pipeline.

In other instances (for example, in remote locations without access to electrical power), there are pipelines transporting various fluids (e.g., crude oil, natural gas, water, LPG products, etcetera) where electrical power is desirable. An example of such a system would be a natural gas transmission line in the far reaches of West Texas, New Mexico, or Arizona. The cost of installing new power lines to remote operating stations are often cost prohibitive, but power availability would make available many operational devices for the pipelines, or for land owners.

Therefore, there is a need for a method, system, and device, which can convert the energy (pressure) stored in a pipeline into mechanical energy that can generate electricity as a stand-alone source.

### SUMMARY

According to a first example of the invention, a gas gathering system is provided comprising: a first well; a first flow line of gas from the first well; a first separator connected to the first flow line; a first separated gas flow line connected to a first input of a means for combining at least two gas flows having different pressures; a second well; a second flow line of gas from the second well; a second separation connected to the second flow line; a second separated gas flow line connected to a second input of the means for combining; wherein the means for combining comprises a first input volume and a second input volume; and a pressure differential between the first input volume and the second input volume causes a portion of the first input volume to be combined with a portion of the second input volume at an output volume.

In another example of the invention, a gas gathering system is provided that comprises: a first input of gas at a first pressure; a second input of gas at a second pressure, the first pressure being higher than the second pressure; a means for combining the first and the second inputs of gas; wherein the means for combining uses pressure differences between the first input of gas and the second input of gas to power the means for combining. At least one such system further comprises a gas/fluid separator receiving gas and fluids from a well; wherein the first input of gas comprises gas from the separator, and a liquids tank, receiving liquids from the separator, and wherein the second input of gas comprises vapor from the tank.

In still another example of the invention, an apparatus is provided that is useful in combining at least two fluids of differing pressures. The apparatus comprising: a housing; a first rotor within the housing; a second rotor within the housing, the first rotor engaging the second rotor and both the first and the second rotors engaging the housing; a third rotor within the housing and engaging the first rotor; a fourth rotor within the housing and engaging the second rotor, the third rotor engaging with the fourth rotor and both the third and the fourth rotors engaging the housing; wherein the first and the second rotors define a first input volume; wherein the third and the fourth rotors define a second input volume; wherein the first and the third rotors define a first output volume; and wherein the second and the fourth rotors define a second output volume.

In at least some such examples, at least two rotors engage each other in a sealing arrangement and are substantially the same size. In other examples, a first pair of the rotors is larger than a second pair of the rotors. In many examples, the rotors are mounted on bearings around fixed shafts; while, in further examples, at least one rotor is fixed to the shaft of the rotor.

In some examples, the housing comprises a substantially cylindrical shape and has sealing surfaces that are arranged to seal with the rotors. Inputs are also substantially normal to the axis of the housing. In further examples, the housing comprises inputs substantially parallel to the axis of the housing.

In yet another example of the invention, a rotor is provided that is useful in an apparatus for combining at least two fluids of differing pressures. The rotor comprises: a set of protrusions; a set of recesses between the protrusions; wherein the protrusions comprise sealing surfaces, at least a portion of the sealing surface comprises a portion of a first circle, the recesses comprise sealing surfaces, at least a portion of the sealing surface comprises a portion of a second circle, the first circle and the second circle are tangential, the first circle and the second circle each have centers located on a circle having a center on an axis of the rotor. Some such rotors form a substantially cylindrical void in their center and rotate on bearings about a shaft. Other such rotors are fixed to a shaft, and the shaft rotates.

In still another example, an apparatus that is useful in turning a shaft is provided. In at least one specific example, the apparatus includes: a housing; a first rotor within the housing; a shaft connected to the first rotor and projecting out of the housing; a second rotor within the housing, the first rotor engaging the second rotor and both the first and the second rotors engaging the housing; a third rotor within the housing and engaging the second rotor; a fourth rotor within the housing and engaging the first rotor, the third rotor engaging the fourth rotor and both the third and the fourth rotors engaging the housing; wherein the first and the second rotors define a first input volume, the third and the fourth rotors define a second input volume, the first and the fourth rotors define a first output volume, and the second and the third rotors define a second output volume. In some such examples, at least two rotors are in a sealing engagement. Some examples also include rotational bearings between the shaft connected to the first rotor and the housing; and, in some such examples, the bearings are located in an end plate of the housing. In an even more specific example, the bearings are located between the second rotor and a substantially non-rotating shaft connected to the housing.

In yet a further example of the invention, a method of turning a shaft is provided, the method comprising: converting a pressure differential across a first rotary member into rotational motion of the first rotary member; applying the rotational motion to the shaft; converting a pressure differential across a second rotary member into rotational motion of the second rotary member; and applying the rotational motion of the second rotary member to the first rotary member. In at least one more specific example, the method also includes converting a pressure differential across a third rotary member into rotational motion of the third rotary member, and applying the rotational motion of the third rotary member to the first rotary member. In still a more specific example, the method further includes converting a pressure differential across a fourth rotary member into rotational motion of the fourth rotary member, and applying the rotary motion of the fourth rotary member to the second rotary member.

In an even further example of the invention, a system for turning a shaft is provided. In some examples, the system includes means for converting a pressure differential across a first rotary member into rotational motion of the first rotary member; means for applying the rotational motion to the shaft; means for converting a pressure differential across a second rotary member into rotational motion of the second rotary member; and means for applying the rotational motion of the second rotary member to the first rotary member.

In a more specific example, the system further includes means for converting a pressure differential across a third rotary member into rotational motion of the third rotary member, and means for applying the rotational motion of the third rotary member to the first rotary member. In an even more specific example, the system also includes means for converting a pressure differential across a fourth rotary member into rotational motion of the fourth rotary member, and means for applying the rotary motion of the fourth rotary member to the second rotary member. In at least one such example, the means for converting a pressure differential across the first rotary member comprises a blade separating a first volume at a first pressure from a second volume at a second pressure. In another example, the means for applying the rotational motion to the shaft comprises a mechanical connection between the rotary member and the shaft. In at least some examples, the shaft rotates substantially coaxially with said first rotational member. The shaft is press-fit in the first rotational members in some examples. In further examples, a shaft is integrally formed with said first rotational member or rigidly connected to the rotational member.

In some examples, the means for converting a pressure differential across a second rotary member into rotational motion comprises a blade separating a third volume from a first volume. Likewise, in some examples, the means for converting a pressure differential across a second rotary member comprises a blade separating a first volume at a first pressure from a second volume at a second pressure; the means for converting a pressure differential across the third rotary member into rotational motion of the third rotary member comprises a blade separating a fourth volume from the second volume; and the means for converting a pressure differential across the fourth rotary member into rotational motion of the fourth rotary member comprises a blade separating the third volume from the fourth volume.

In yet another example of the invention, a method of reducing pressure in a natural gas line is provided. An example of the method comprises: receiving natural gas at a first input at an input pressure, whereby there is a pressure differential established across a first rotary member; converting the pressure differential into rotational motion of the rotary member; regulating a load on the first rotary member; and passing the gas through rotation of the rotary member to an output, wherein the regulation of the load on the first rotary member maintains the pressure of the gas at the output between a range of pressures below the input pressure. In at least one such example the method also comprises converting a pressure differential across a second rotary member into rotational motion of the second rotary member, and applying the rotational motion of the second rotary member to the first rotary member. In at least one more specific example, the method also includes receiving natural gas at a second input at the input pressure, whereby there is a pressure differential established across a third rotary member; converting the pressure differential across the third rotary member into rotational motion of the third rotary member, and applying the rotary motion of the third rotary member to the first rotary member. In some such examples, the method further comprises converting a pressure differential across a fourth rotary member into rotational motion of the fourth rotary member, and applying the rotational motion of the forth rotary member to the second and the third rotary members.

In an even further example of the invention, a system of reducing pressure in a natural gas line is provided. The system comprises: means for receiving natural gas at a first input at an input pressure, whereby there is a pressure differential established across a first rotary member; means for converting the pressure differential into rotational motion of the rotary member; means for regulating a load on the first rotary member; means for passing the gas through rotation of the rotary member to an output, wherein the regulation of the load on the first rotary member maintains the pressure of the gas at the output between a range of pressures below the input pressure. In some such examples, the system also includes means for converting a pressure differential across a second rotary member into rotational motion of the second rotary member, and means for applying the rotational motion of the second rotary member to the first rotary member. In an even more specific example, means is provided for receiving natural gas at a second input at the input pressure, whereby there is a pressure differential established across a third rotary member, along with means for converting the pressure differential across the third rotary member into rotational motion of the third rotary member, and means for applying the rotary motion of the third rotary member to the first rotary member. In an even further example, the system also includes means for converting a pressure differential across a fourth rotary member into rotational motion of the fourth rotary member, and means for applying the rotational motion of the forth rotary member to the second and the third rotary members.

In some such examples, the means for receiving natural gas at a second input at the input pressure comprises the pressure housing, the third rotor, and the fourth rotor, wherein the third rotor and the fourth rotor are in meshed contact with each other and in movable sealing contact with the housing to define a second input volume. In some examples, the means for converting the pressure differential across the third rotary member into rotational motion of the third rotary member comprises protrusions from the rotary member. Likewise, in some examples, the means for applying the rotary motion of the third rotary member to the first rotary member comprises protrusions of the third rotary member meshed with protrusions from the first rotary member.

In at least one more specific example, the system includes means for converting a pressure differential across a fourth rotary member into rotational motion of the fourth rotary member, and means for applying the rotational motion of the forth rotary member to the second and the third rotary members.

In at least one example, the means for receiving natural gas at a first input at a first input pressure comprises a pressure housing having at least two rotors in meshed contact with each other and in movable sealing contact with the housing to define a first input volume. In a further example, the means for converting the pressure differential into rotational motion of the rotary member comprises protrusions from the rotary member. In still another example, the means for regulating a load on the first rotary member comprises a generator being mechanically connected to the first rotary member. In yet another example, the means for passing the gas through rotation of the rotary member to an output comprises multiple protrusions trapping gas in the input volume between themselves and the housing and rotating the trapped gas to an output volume. In an even further example, the means for converting a pressure differential across a second rotary member into rotational motion of the second rotary member comprises protrusions from the second rotary member. Still another example includes a means for applying the rotational motion of the second rotary member to the first rotary member that comprises protrusions of the first rotary member meshed with protrusions from the second rotary member.

The above are merely some examples of the invention, which is not intended to be defined or limited by the above.

### BRIEF DESCRIPTION OF THE DRAWINGS

FIGS. 1A-1D are a schematic of an example of the invention.

FIG. 2 is a perspective view of an example of the invention.

FIG. 3 is a side view of an example of the invention.

FIG. 4 is a perspective view of an example of the invention.

FIG. 5 is a side view of an example of the invention.

FIGS. 6A-6H are perspective views of examples of the invention.

FIG. 7 is an exploded view of an example of the invention.

FIGS. 8-11 are sectional views of examples of the invention.

FIG. 12 is a perspective view of an example of the invention.

FIG. 13 is a sectional view of an example of the invention.

FIG. 14 is a perspective view of an example of the invention.

FIG. 15 is a schematic of an example of the invention.

FIG. 16 is a perspective view of an example of the invention.

FIG. 17 is a perspective view of an example of the invention.

FIG. 18 is a cut-away view of the example of FIG. 17.

FIG. 19 is a detailed view of an area of FIG. 18.

FIG. 20 is a detailed view of an area of FIG. 18.

FIG. 21 is a perspective view of an example of the invention.

FIG. 22 is a cut-away of the example of FIG. 21.

FIG. 23 is a detail of an area of FIG. 22.

FIG. 24 is a perspective view of an example of the invention.

FIG. 25 is a cut-away of the example of FIG. 24.

FIG. 26 is a detail of the example of FIG. 25.

FIG. 27 is a schematic view of an example of the invention.

### DETAILED DESCRIPTION OF EXAMPLE EMBODIMENTS OF THE INVENTION

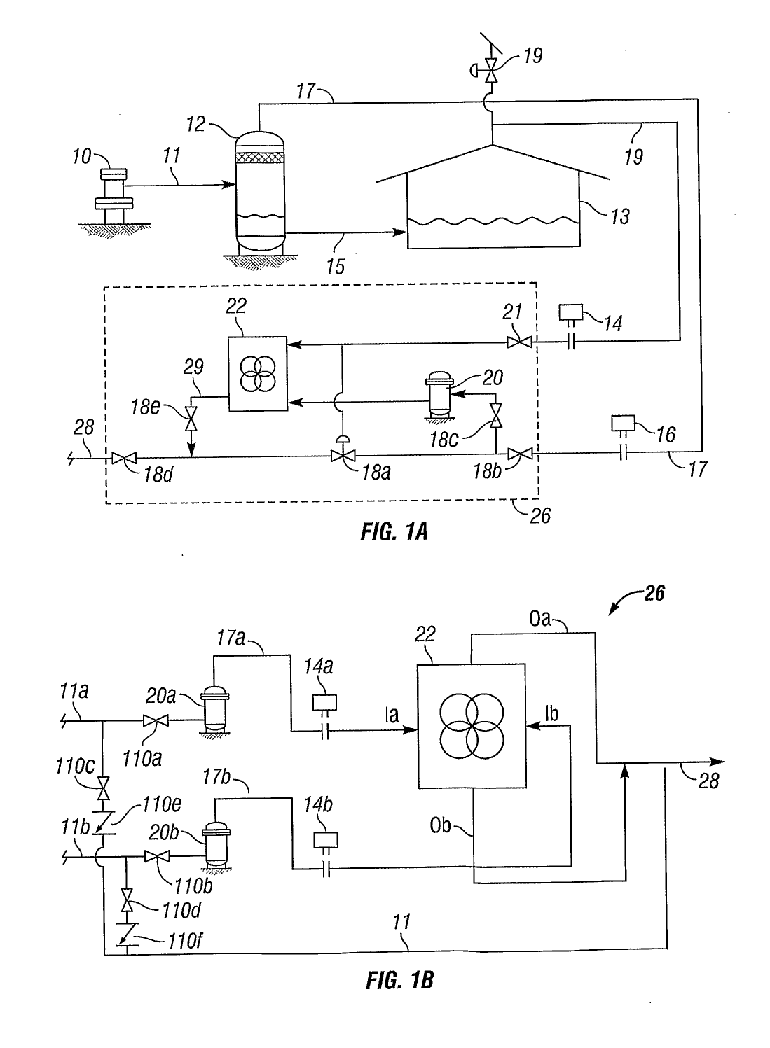

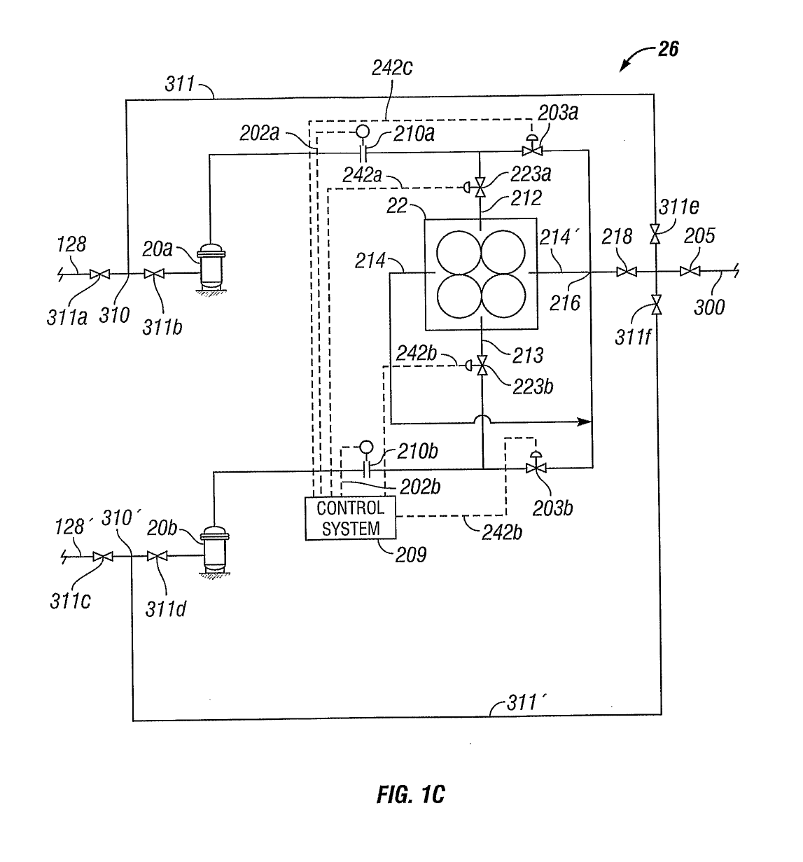

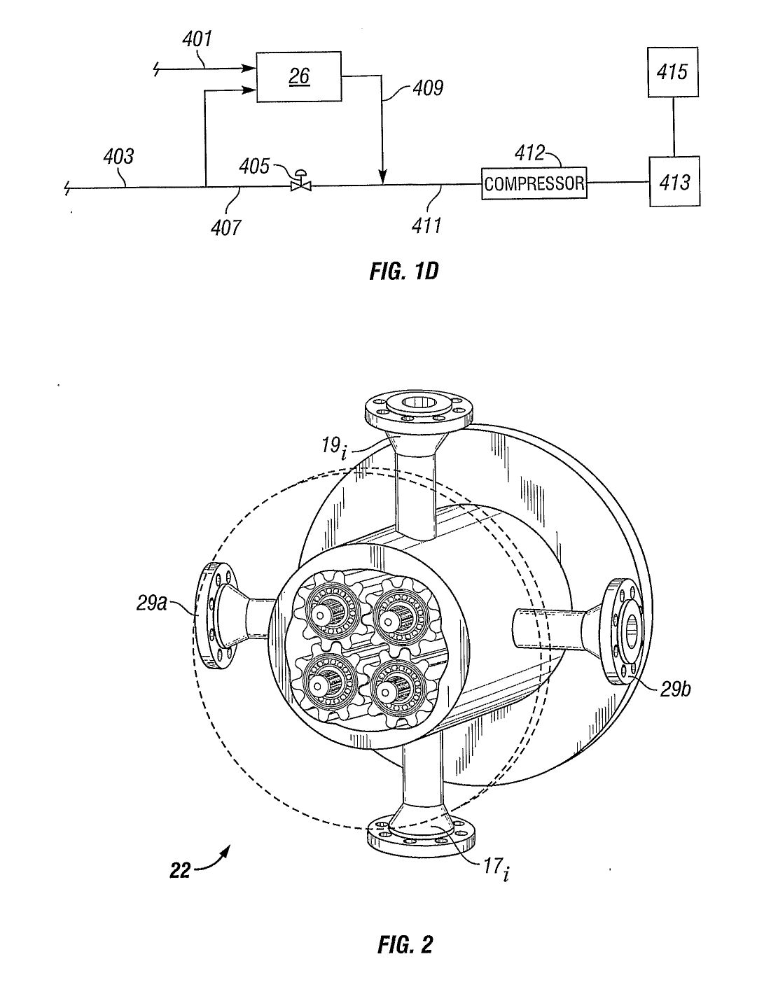

FIG. 1A illustrates an example of the invention in which a flowing well 10 sends gas to separator 12 over flow-line 11. From separator 12 (of a common design known to those of skill in the art), liquids pass through liquid transfer line 15 into storage tank 13. Gas passes from separator 12 onto gas flow line 17. Vapor from liquid storage tank 13 is removed from liquid storage tank 13 via vapor flow line 19. The pressure and gas flow line 17 is higher than the pressure in vapor flow line 19. Therefore, combiner unit 26 is provided to combine the fluid flow from gas flow line 17 and vapor flow line 19 into a single combined gas flow line 28.

Vapor flow line 19 is passed through vapor flow meter 14 and enters combiner unit 26 at valve 21. Gas flow line 17 is passed through gas flow meter 16 and enters combiner unit 26 at valve 18b. Valve 18a opens and closes in response to a pressure transmitter (not shown), which is located in line 19 and controls whether the higher pressure gas passes directly through combiner unit 26 to gas flow line 28 or whether it will be combined with vapor from vapor flow line 19. Valves 18a, 18b, 18c, 18d, 18e, and/or 21, comprise manually operated valves (in some examples), which remain in an open position until it is necessary to perform maintenance or repairs; then, they are closed to isolate unit 26. For example, if valve 18a is closed, and valves 18b and 18c are open, gas flows from gas flow line 17 through solids filter 20 and into combiner component 22 (also sometimes referred to herein as a means for combining). When valve 21 is open, vapor flowing at a low pressure from vapor flow line 19 also enters combiner component 22. In some other examples, one or more of valves 18a-18e or 21 comprise automated-operation valves.

Combiner component 22 combines the gas flow and vapor flow, resulting in an individual flow that is at a pressure between the pressure of the gas and the vapor, and that individual flow is passed through valve 18e onto combined gas flow line 28 by the opening of valve 18d with valve 18a closed.

In at least some alternative embodiments, filter 20 is not used. Likewise, in some alternative embodiments, vapor flow meter 14 and/or gas flow meter 16 are not used. A pressure release valve 19 is seen connected to liquid storage tank 13 for the purpose of venting excess pressure build-up in liquid storage tank 13 either to air, a traditional compressor, or a flare (in the event of a problem downstream of liquid storage tank 13).

Referring now to FIG. 1B, another example embodiment of a combiner unit 26 is seen in which at least two flow lines 11a and 11b from independent wells (not shown) feed into solids filters 20a and 20b through valves 110a and 110b. Valves 110c and 110d allow communication between flow lines 11a and 11b in an open state and isolates flow lines 11a and 11b in a closed state. Check valves 110e and 110f prevent back flow.

Gas flow lines 17a and 17b are fed through flow meters 14a and 14b respectively into inputs Ia and Ib of combiner component 22. Gas from different wells may flow at different pressures and/or flow rates, and the flow from any particular well may fluctuate greatly. For example, wells having pumping mechanisms and/or having pressure-sensitive valves that open upon the well pressure reaching a particular level allow flow until the well pressure drops below a different level; they then close the well again, allowing pressure to build. Because of this, without a combiner component 22, it is difficult and costly to take the production of multiple wells and combine them into a single line 28. Furthermore, the production from the lesser wells is limited beyond its otherwise producing capability by the production from the greater wells; and, further still, the pressure the artificial lift mechanism must overcome is higher. Combiner component 22 takes the flows at inputs Ia and Ib and combines them into a plurality of outputs to form flow line 28. In the illustrated example, two outputs, Oa and Ob, are substantially the same pressure and flow rate at a given moment in time and are connected together (e.g., by a joint, manifold, or other form of or means for combining substantially similar flows).

Valves 110a, 110b, and 110c, allow a bypass of filters 20a and 20b and of combiner component 22, when valves 110a and 110b are in a closed state and valve 110c is in an open state. In such a case, the higher pressure and flow rate line 11a or 11b will dominate the flow into flow line 11 and then into flow line 28. In those systems in which the flow rates and pressures of the wells fluctuate, the flow line that dominates will fluctuate between line 11a and 11b. However, such an arrangement allows for maintenance of the filters 20a and 20b and of combiner component 22.

FIG. 1C illustrates a further example embodiment of a combiner unit 26 in which flow line 128 feeds into solids filter 20a through valves 311a and 311b, and flow line 128′ feeds into solids filter 20b through valves 311c and 311d. When valve 311a is in a closed state, there is no flow from line 128. When valve 311a is in an open state, flow occurs through bypass line 311, if valve 311e is in an open state and valve 311b is in a closed state, through T-joint 310. There is no flow in bypass line 311 when valve 311e is in a closed state and valve 311b is in an open state, and flow then continues into solids filter 20a. Similarly, flow line 128′ is fed into solids filter 20b when valves 311c and 311d are in open states while valve 311f is in a closed state, and flow line 128′ bypasses filter 20b through T-joint 310′ when valve 311d is in a closed state and valve 311f is in an open state. Valve 218 is closed in the bypass state of the system.

Control system 209 monitors meters 210a and 210b through signal paths 202a and 202b. In the illustrated example, meters 210a and 210b comprise differential pressure meters. Other examples utilize other means for measuring pressure that will occur to those of skill in the art. Control system 209, through signal paths 242a and 242b, operates control valves 223a and 223b (based on inputs from meters 210a and 210b, respectively), to control input to combiner component 22. In conjunction with valves 203a and 203b, which are also controlled from control system 209 (through signal paths 243c and 243d), valves 223a and 223b bypass combiner component 22 under the following conditions (among others): (i) when both inlet streams 128 and 128′ have pressure sufficient to enter line 300 without negative effect on production sources, (ii) line 128 or 128′ does not flow, or (iii) during periods of routine maintenance or repair.

In other situations, the flow from filter 20a enters an input of combiner component 22 and the flow from filter 20b enters another input of combiner component 22. As previously mentioned, their pressures and flow rates are combined into a single flow line 300 through outputs tied to lines 214 and 214′, through joint 216 (here, a cross), valves 218, and shut off valve 205.

Referring now to FIG. 1D, a further alternative is seen in which a gas flow line 401 (e.g., of an individual well at 25 psi) and a second gas flow line 403 (for example, a gas gathering system trunk line at 500 psi) are input into combiner unit 26 (e.g., as seen in FIGS. 1A, 1B, and/or 1C), when valve 405 is in a closed state. The combiner unit 26 (also referred to as a means for merging, a merge unit, and/or a means for gas boosting) combines the pressures and flow rates of the flow lines 401 and 403 into flow line 409 (resulting in a combined pressure between 500 psi and 25 psi) which is then fed as an input to compressor 412. Compressor 412 steps up the pressure in flow line 411 to a higher pressure (for example, main line pressure).

In many situations, the higher pressure and volume of the main line are enough that the compressor 412 is unneeded. In such a situation, output 411 becomes an input to a system of the same basic layout as seen in FIG. 1D. The main line is line 403 and the gathering system output is line 401. In some such examples, the pressure and flow rate of lines 401 and 403 will be such that there will be a negligible drop in pressure between lines 403 and 411 while still combining the volume of line 401 into compressor 412, which compresses the pressure to be used by other downstream systems 413 and/or 415.

Referring now to FIG. 2, an example of combiner component 22 (also sometimes referred to as a means of combining) of FIGS. 1A-1D is seen. For example, gas flow line 17 (FIG. 1A) is connected to bottom input 17i and vapor flow line 19 (FIG. 1A) is connected to top input 19i. The two fluid flows from gas flow line 17 and vapor flow line 19 are combined in combiner component 22 (as will be explained in more detail below) and output through outlets 29a and 29b. The flow from outlet 29a is at substantially the same pressure and rate as in outlet 29b and the two are combined (for example, through a direct connection such as a joint or manifold) and then applied (in the example of FIG. 1A) through outlet line 29 and control valve 18e to combined gas flow line 28.

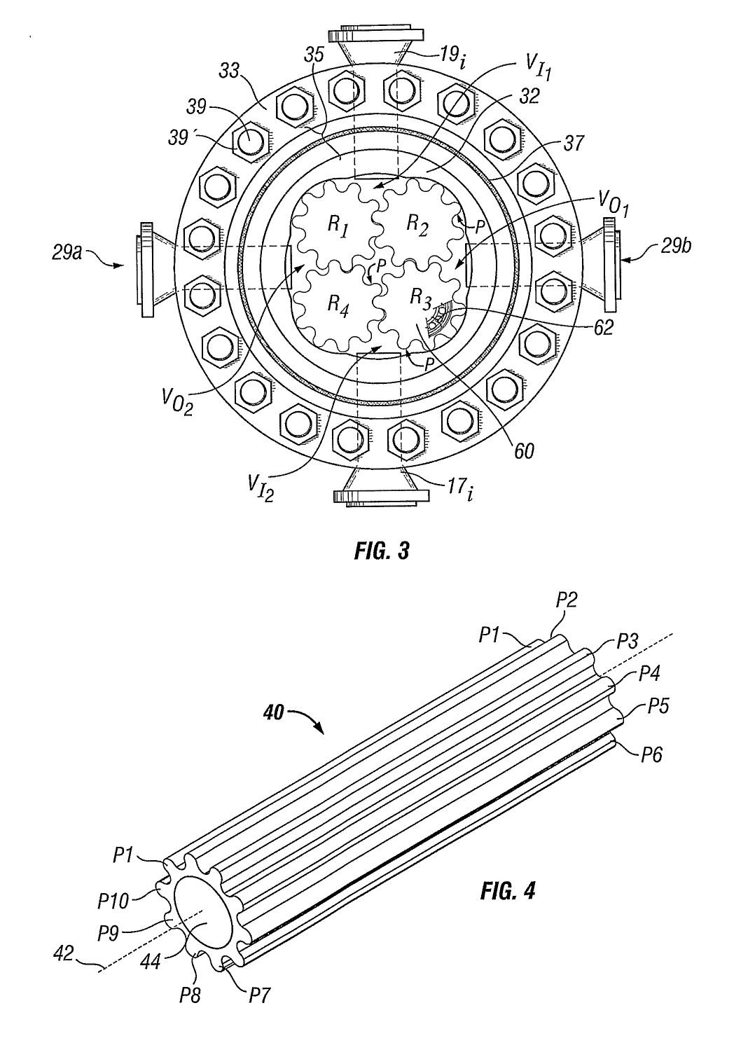

In FIG. 3, an end-view of the example combiner component 22 of FIG. 2 is seen in which vapor from vapor line 19 enters through top inlet 19i to form inlet volume VI₁ (defined between rotors R1 and R2 and inner housing pipe 32). Gas flows from flow line 17 through bottom inlet 17i into the second inlet volume VI₂ (defined between rotors R4 and R3 and inner housing pipe 32).

In operation, the high pressure in inlet volume VI₂ causes rotor R4 to rotate clockwise while rotor R3 rotates counter-clockwise. Likewise, rotor R1 rotates counter-clockwise while rotor R2 rotates clockwise. Rotor protrusions P seal against inner housing pipe 32 as they rotate and again seal as they mesh with their neighboring rotors. Therefore, fluid in inlet volumes VI₁ and VI₂ are passed between protrusions P and inner pipe housing 32 into outlet volumes VO₁ and VO₂. When those fluid flows reach outlet volumes VO₁ and VO₂, they combine. In both outlet volumes VO₁ and VO₂, the pressure level is between the pressure level in inlet volumes VI₁ and VI₂. Further, the pressure in VO₁ is about the same as the pressure in VO₂, and the flow in outlet volume VO₁ is equal to the flow in outlet volume VO₂. Therefore, outlets 29a and 29b can be directly combined (for example, through a simple joint or manifold).

Referring now to FIG. 4, a perspective view of an example is seen of a rotor 40, which is useful in the example of FIG. 3 for rotors R1, R2, R3, and R4. Rotor 40 comprises a member having substantial symmetry about an axis 42 having ten protrusions P1-P10. Rotor 40 also includes a cylindrical void 44. In at least some examples, rotor 40 comprises steel, ceramic, and/or other materials that will occur to those of skill in the art.

In some examples, the outer diameter shape of rotor 40 is formed by an EDM machine. As used herein, EDM stands for electrical discharge machining, a process that is known to those of skill in the art. In some examples, the cylindrical void 44 is also formed by an EDM process. In other examples, cylindrical void 40 is bored and the outer shape is cut by an EDM process.

Still other examples of methods of forming rotors include CNC (Computer Numerical Control) machining, extrusion, and other methods that will occur to those of skill in the art.

While the example of FIGS. 3 and 4 shows rotors with ten protrusions, the invention is not limited to such an example. Other numbers of protrusions are useful according to other examples of the invention, as will be explained in more detail below.

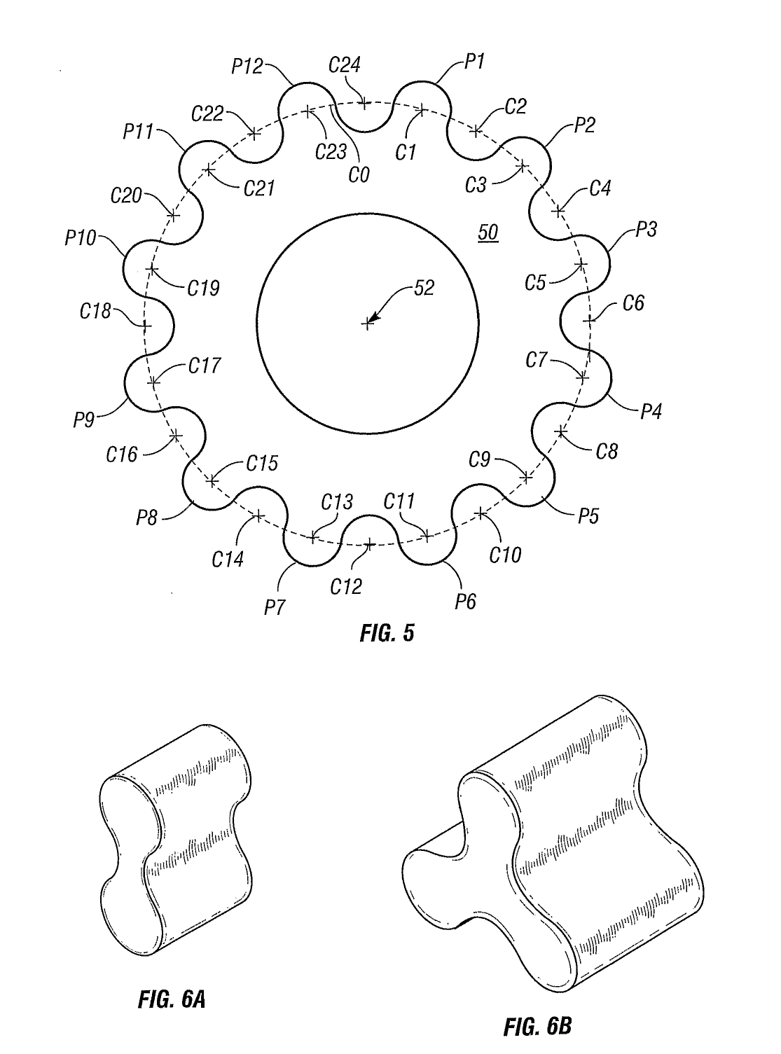

Referring to FIG. 5, a cross-sectional view of an example rotor 50 is seen having twelve protrusions P1-P12. Each of protrusions P1-P12 is formed according to a set of circles, each of which has its center C1-C24 located on a larger circle C0. C0 has its center on axis 52 of rotor 50.

Referring again to FIG. 3, as the rotors R rotate, the protrusions P seal with the recess between protrusions in adjacent rotors. In example embodiments in which the relationship of the number of protrusions to the diameter of circle C0 is maintained, the protrusions P engage in a substantially non-sliding manner when two rotors are rotated in connection with each other. Lack of a sliding engagement provides the following benefits: lack of friction, extrusion of the material in the volume (rather than compression), and reduced wear. While, in some other examples, non-circular shapes may be used, curved shapes (and, in particular, a circular shape) provide advantages of sealing the outer volumes VI₁, VI₂, VO₁, and VO₂, from each other and from the interior volume defined by the four rotors R1, R2, R3, and R4.

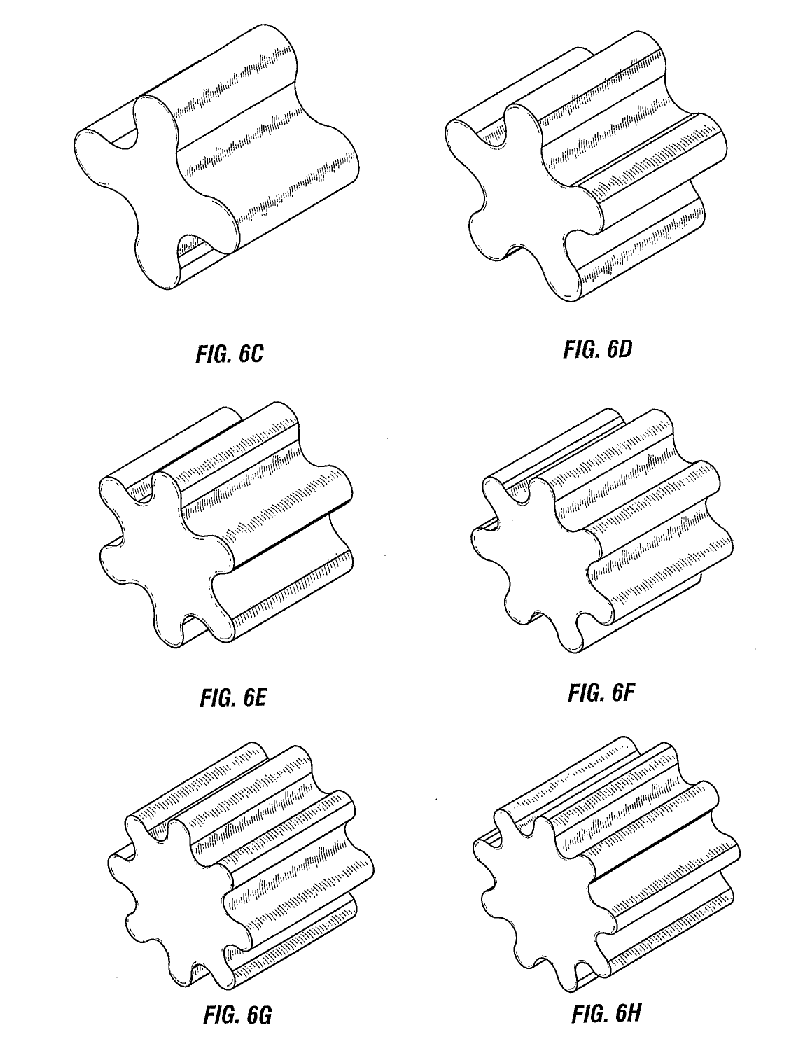

Referring still to FIG. 3, the more protrusions that exist, the better the seal is between the protrusions P and inner pipe housing 32. However, given the same diameter, the more protrusions P that exist, the smaller the volume is that can be moved per rotation from an inlet volume to an outlet volume (for example, VI₁ to VO₁). Further examples of rotors useful according to other examples of the invention are seen in FIGS. 6A-6H, where a cylindrical void is not shown. There is no theoretical limit to the number of protrusions in various examples of the invention.

Referring again to FIG. 3, rotors R1, R2, R3, and R4 are shown solid for simplicity; however, in reality, the cylindrical void of each of the rotors includes a shaft and a bearing member 62, as also seen in FIG. 2. In the examples of FIGS. 2 and 3, bearing member 62 comprises a ball-bearing assembly (although other means for providing low friction rotation between a fixed shaft and a rotor also are useful in further examples of the invention). Still further, in other examples, rotors R do not spin around a shaft; rather, they are integrally formed with or connected in a fixed manner to the shaft, and the shaft spins on bearings mounted in the housing or an end plate. Further means of providing for rotational motion of rotors R will occur to those of skill in the art in view of the present disclosure that are within the scope of the present invention.

Even further, although the illustrated examples show rotors of substantially the same size, in alternative examples, a pair of rotors is of smaller diameter than another pair of rotors allowing for differences in the volume handled by the different inputs.

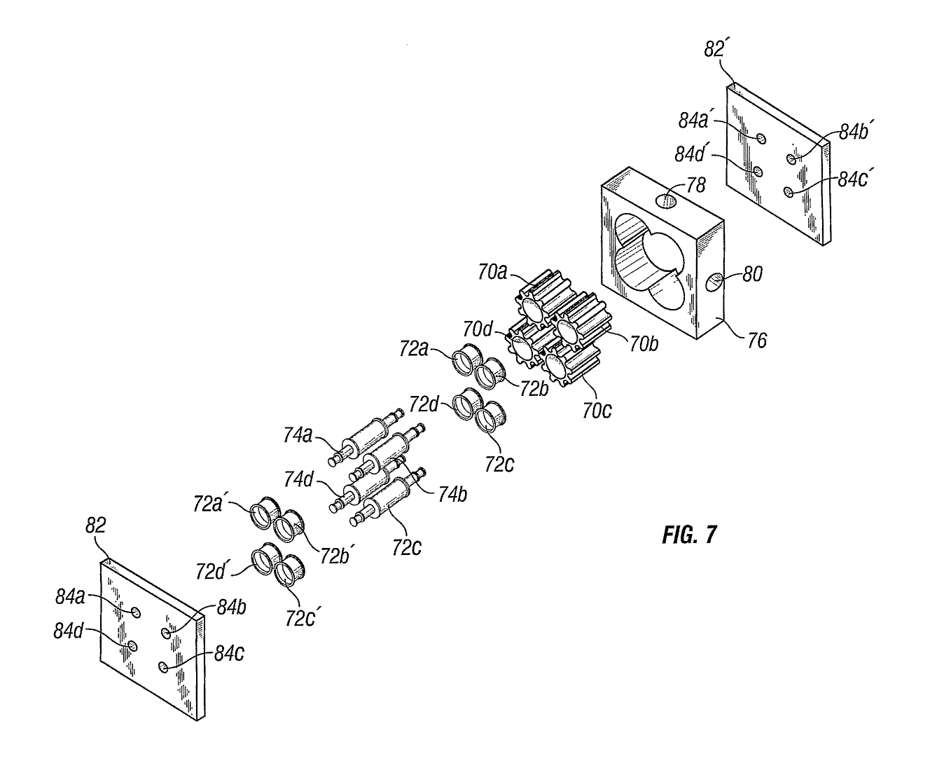

Referring now to FIG. 7, an example embodiment is seen in an exploded view in which shafts 74a-74d each have two bearings. For example, shaft 74a has bearing 72a and 72a; shaft 74b has bearings 72b and 72b′, etcetera. Rotors 70a-70d rotate on the bearings 72a-72d and 72a′-72d′. Shafts 74a-74d are fixed.

Rotors 70a-70d form inlet and outlet volumes in cooperation with each other and block 76 in which one inlet port 78 and one outlet port 80 are seen. The other inlet port is on the bottom of block 76 (not shown) and the other outlet port is on the fourth side of block 76 (also not shown). When assembled inside of block 76, shafts 74a-74d are mounted in end plates 82 and 82′ through holes 84a-84d and 84a′-84d′.

In at least one example method of assembly, shims (not shown) are wrapped around rotors 70a-70d to set a consistent clearance between the block 76 and rotors 70a-70d. Dowel-pin holes (also not shown) are then drilled through end plates 82 and 82′ and into block 76. The shims are then removed and the apparatus is re-assembled with the correct clearance, using the dowel-pin holes as a guide.

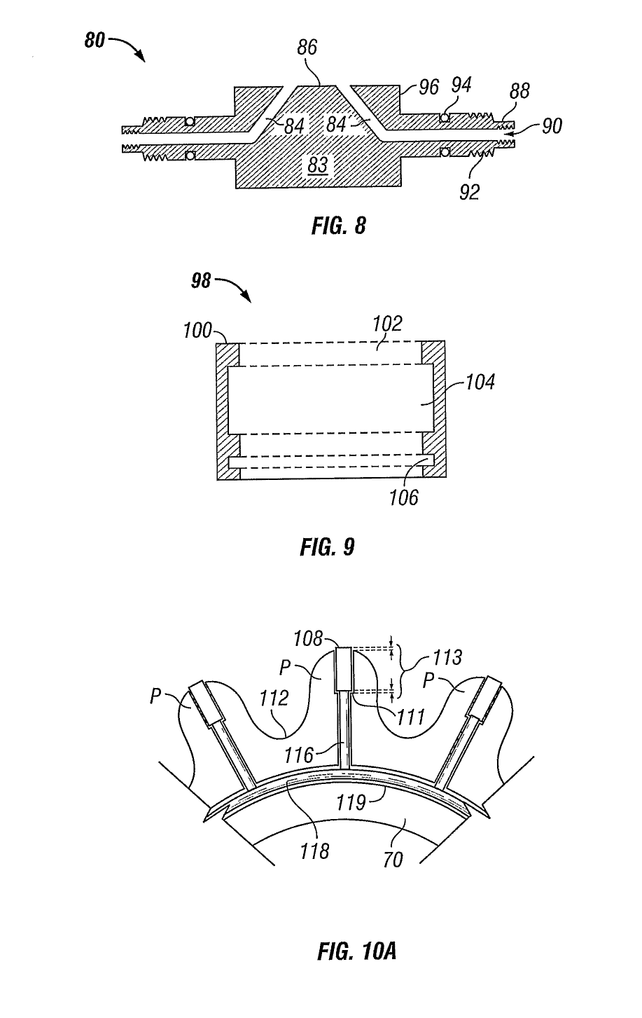

Referring now to FIG. 8, a sectional view of an example of a shaft useful in the example of FIG. 2, 3, or 7 is seen. According to the example of FIG. 8, shaft 80 includes a shaft body 83 including a first oil path 84 and a second oil path 84′. Lubricated surface 86 of shaft 80 receives lubrication through oil paths 84 and/or 84′ through an oil fitting 88, which includes oil port 90. Threads 92 allow shaft 82 to be connected in a fixed manner with a nut (not shown) outside of end plates 82 and 82′ (FIG. 4). O-ring 94 is used to seal shaft 80 with end plates 82 and 82; shoulder 96 butts up against end plates 82 and 82′ providing an end-seal to prevent leakage of lubrication from lubricated surface 86.

FIG. 9 shows a cross-section of an example of a babbit bearing housing 98 that is useful as a bearing in various examples of the invention. A substantially cylindrical body 100 includes a shaft hole 102. Within shaft hole 102, a babbit material cavity 104 is formed to receive babbit material, which is not shown in FIG. 9. Also included in shaft hole 102 is an O-ring seal groove 106.

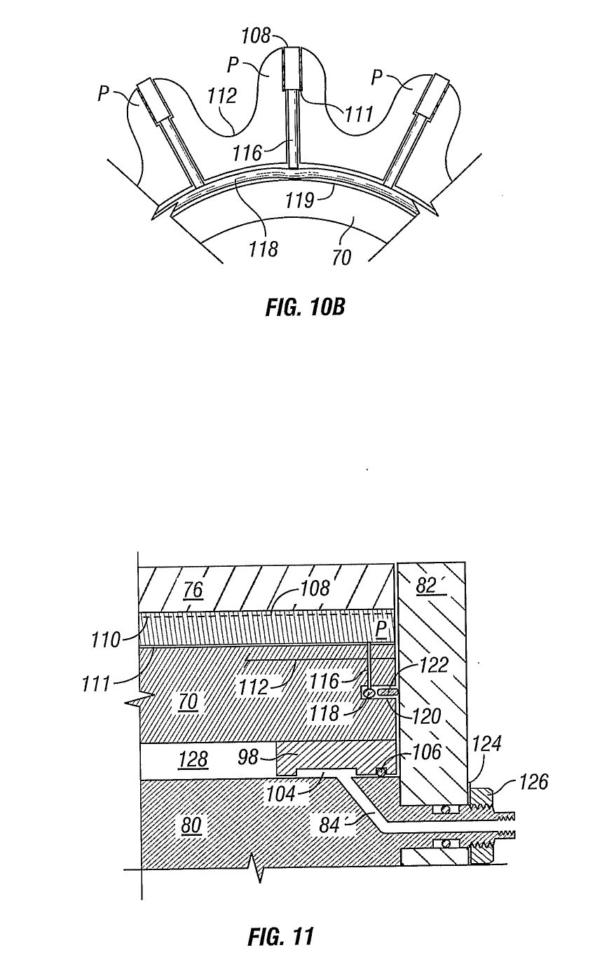

In some embodiments of the invention, the seal between rotors or between a rotor and the non-rotating housing or block is enhanced by a means for sealing (e.g., a seal member or blade) that extends from each protrusion. An acceptable example of such a means for sealing is seen in FIG. 10A, which is a cross-section of a rotor R having protrusions P, which include a longitudinal blade 108 and a pin 116. When a protrusion is not either mated in the recess 112 between two protrusions P of another rotor or engaged against the housing, blade 108 is in an extended position 113 from the bottom of channel 111 and is biased by an O-ring 118, which is held in a groove 119 of rotor 70. As seen in FIG. 10B, when a protrusion (here the middle protrusion) engages another rotor, blade 108 is compressed into protrusion P and pin 116 compresses O-ring 118, slightly. Blade 108 may still extend slightly from protrusion P, as discussed below. For simplicity, stop surfaces used to hold blade 108 in protrusion P are not shown but will occur to those of skill in the art. In some examples, blade 108 is flat, as seen; in further examples, the extended surface of blade 108 is curved.

Referring now to FIG. 11, a cross-sectional view of an example assembled shaft bearing, and rotor, is seen. The top 110 of protrusion P of rotor 70 in the example shown is in a dashed line; blade 108 rides between the bottom of blade channel 111 in protrusion P and an extended position at the top-most travel of blade 108. As mentioned previously, blade 108 is positioned in a biased manner by pin 116 and a biasing means (for example, an O-ring) 118 that is held in a groove 120 and closed by an end seal 122. As briefly described earlier with reference to FIG. 8, a nut 126 backed by washer 124 fixes shaft 80 against end plate 82′.

During operation, as rotor 70 spins around bearings 98, and (as both bearings spin around shaft 80) a lubricant (e.g., oil) is supplied through lubrication paths 84 and 84′ under babbit material (not shown) in cavity 104, lubricant moves between bearings 98 to substantially fill oil chamber 128 and to flow from shaft 84′ to shaft 84 (or the reverse). The presence of a fluid in contact bearing 98 and/or rotor 70 also acts as a coolant of the member with which the coolant is in contact.

Referring still to FIG. 11, the top of blade 108 extends against the sidewall of block 76 (or, for example, inner pipe 32 of FIG. 3) to form a seal. There may be a very slight gap without blade 108, in some examples. In some examples that do not use a blade, the motion of the protrusion in close proximity to block 76 is believed to create a “labyrinth seal” or “sonic seal” due to turbulence. In some examples of the invention in which a labyrinth seal might not be relied on, blade 108 adds an additional seal. As rotor 70 turns to engage another rotor, blade 108 compresses within protrusion P. In further examples, neither a labyrinth seal nor a means for sealing (such as blade 108) is used.

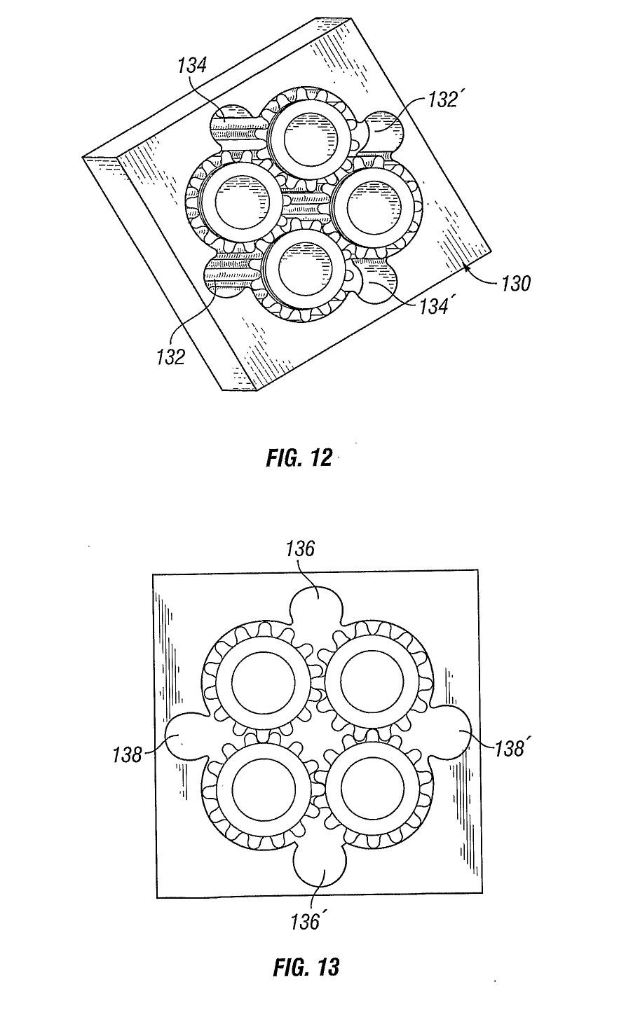

Referring now to FIG. 12, an alternative for block 76 of FIG. 7 is seen. Block 130 includes ports that are in parallel to the axes of rotation of the rotors. By contrast, in FIG. 7, block 76 is ported with inlet and outlet ports 78 and 80, which are normal to the axes of rotation of rotors 70a-70d. Specifically, in block 130 of FIG. 12, inlet ports 132 and 132′ are provided opposite each other, and outlet ports 134 and 134′ are also opposite each other. Such parallel porting reduces the potential for axial pressure differentials within any particular pressure volume.

A cross-sectional view of block 130 is seen in FIG. 13 where it is seen that ports 136, 136′ and 138, 138′, respectively, are larger than in the example embodiment of FIG. 2 and FIG. 3. There, the circular configuration of the housing pipe 32 (which is in place of block 130 of FIG. 12 or block 76 of FIG. 7) defines smaller volumes. By adjustment of the length of the rotor, number of teeth, and diameter of the rotor, adjustment of the volume transferred per protrusion, matching of volumes, and varying pressure differentials between inputs is accommodated.

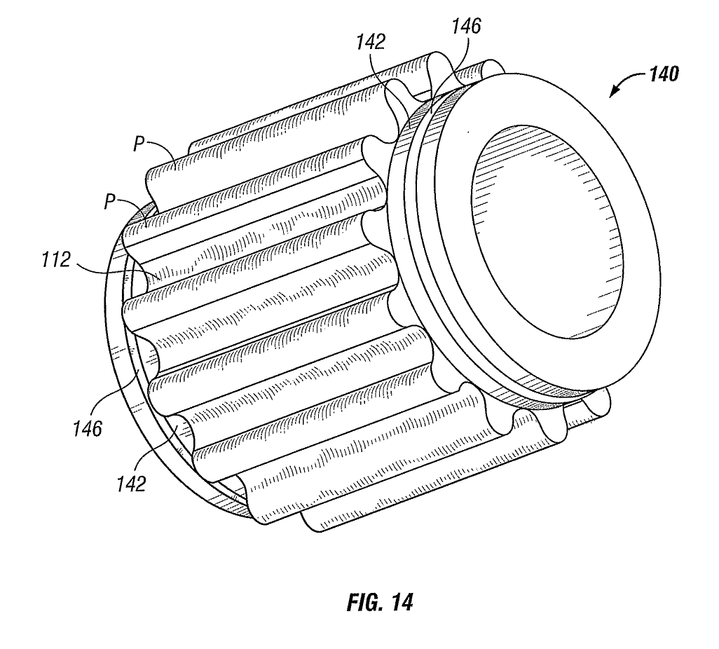

Referring to FIG. 14, an alternative rotor 140 is seen that includes protrusions P (as in earlier-described rotors) and that also includes a sealing surface 142 that is substantially flush with the bottom of the recess 112 between protrusions P. Such a sealing surface operating in conjunction with a seal in an end plate reduces the chance of the fluid, which becomes trapped between protrusions P, from leaking laterally around a protrusion. Groove 146 is cut in the sealing surface 142 to accept a means for sealing (for example, a ring seal of spring steel, an O-ring, etcetera) to further seal and prevent axial leakage.

Referring again to some examples similar to FIG. 3, once inner housing pipe 32 is assembled with rotors R1, R2, R3, and R4, a flange 33 is slipped over inner pipe housing 32 on both ends and welded to pipe 32. A raised face 35 of slip-on flange 33 is provided onto which O-ring seal channel 37 is formed. In place of the end plates 82 and 82′ of the embodiment of FIG. 7, a blind flange (not shown) is mated with the slip-on flange 33 and secured with bolts 39 and nuts 39′. O-ring seal 37 mates with a complimentary raised face and O-ring groove on the blind flange (not shown).

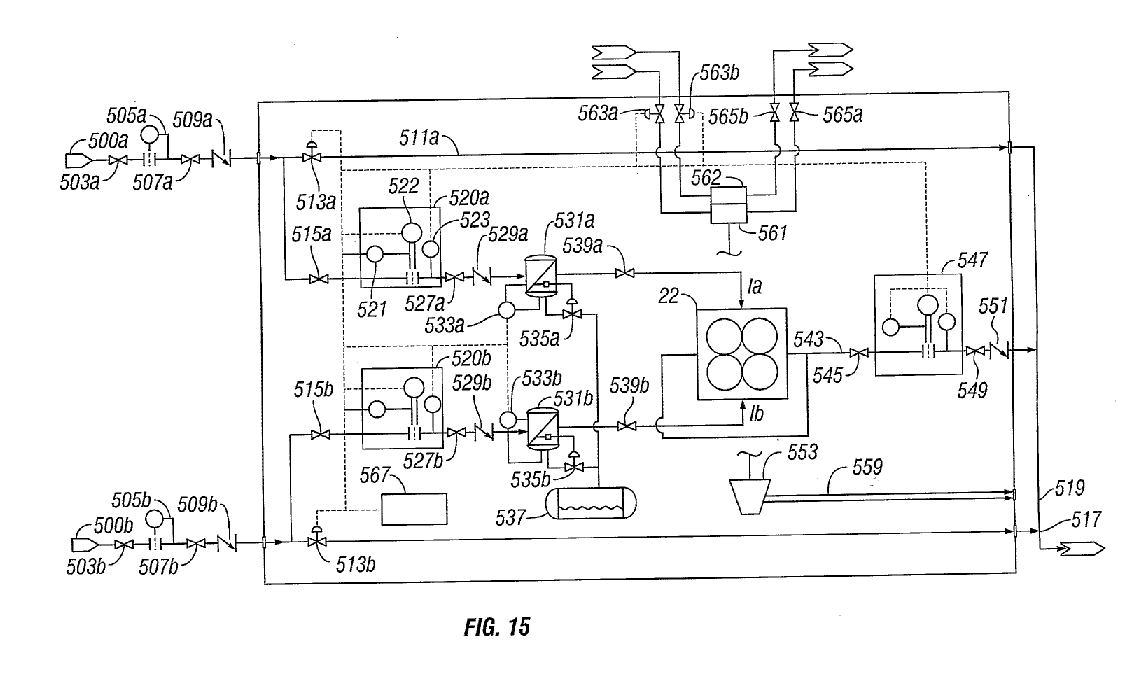

Referring now to FIG. 15, still a further example of a merge unit system 26 is seen in which flow line inputs 500a and 500b connect through valves 503a and 503b and means 505a and 505b for measuring pressure (e.g., a differential pressure meter) and then through check valves 509a and 509b. Bypass lines 511a and 511b operate (when valves 513a and 513b are in an open state, and valves 515a and 515b are in a closed state) and are connected at a joint 517 in output flow line 519. When valves 513a and 513b are in a closed state, and valves 515a and 515b are in an open state, gas flows through measurement packages 520a and 520b (each comprising, in at least one example, a pressure measurement device 521, a differential pressure measurement device 522, and a temperature measurement device 523). Fluid then passes through valves 527a and 527b, through check valves 529a and 529b and into separators 531a and 531b, which are monitored by differential pressure measurement devices 533a and 533b, respectively. Float-actuated valves 535a and 535b operate to remove liquid from separators 531a and 531b and pass the liquid to tank 537.

Vapor from separators 531a and 531b passes through valves 539a and 539b into inputs Ia and Ib of combiner component 22, when valves 539a and 539b are in an open state. Combiner component 22 combines the pressures and fluid flows as discussed previously into output line 543 through valve 545 and measurement package 547. Fluid then flows through valves 549 and check valve 551 and into flow line 519. In such an operation, valves 513a and 513b are in a closed state.

In some embodiments, combiner component 22 has shafts that, rather than being fixed, rotate with the rotors. In at least one such embodiment, a shaft is used to turn an electrical generator 553, which produces power seen in output power lines 559. A rotational shaft of a rotor, in a further embodiment, is used to turn pumps 561 and 562 having input valves 563a and 563b and output valves 565a and 565b, respectively. Examples of inputs at valves 563a and 563b include liquids from oil or water at a well location to a central location, thus avoiding transport costs or for reinjection.

A control box 567 operates valves 563a and 563b, along with valves 513a and 513b, in response to measurements from measurement packages 520a and 520b and differential pressure measurement devices 533a, 533b, and 547. In some embodiments, solids filters similar to those shown in earlier figures are used.

As mentioned previously conversion of energy stored as pressure to mechanical is still another benefit of at least some examples. By providing an output shaft that rotates with at least one rotor, a drop in pressure from an input volume to an output volume turns the output shaft. This allows the energy in the pressurized gas to be converted to mechanical energy and used in remote power locations or where, for example, gas customers have to down-regulate the high pressure of the gas on a transmission line to a lower, useable pressure.

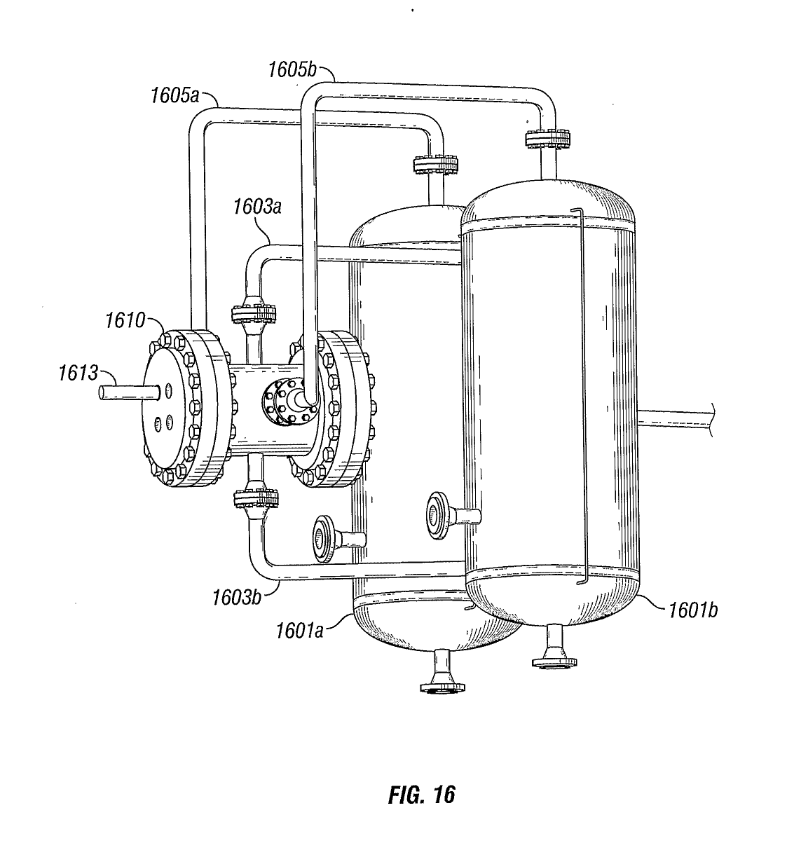

Referring now to FIG. 16, a further example embodiment is seen in which a pressure source (here tanks) tanks 1601a and 1601b provide pressurized flow through input lines 1605a and 1605b into yet another example combiner unit 1610 that includes an output shaft 1613. The outputs from combiner unit 1610 enters flow lines 1603a and 1603b, which are joined at a union (not shown). The pressure from the tanks may be the same or different from each other. Such a combiner unit 1610 is useful in still further examples in the systems described in previous Figures.

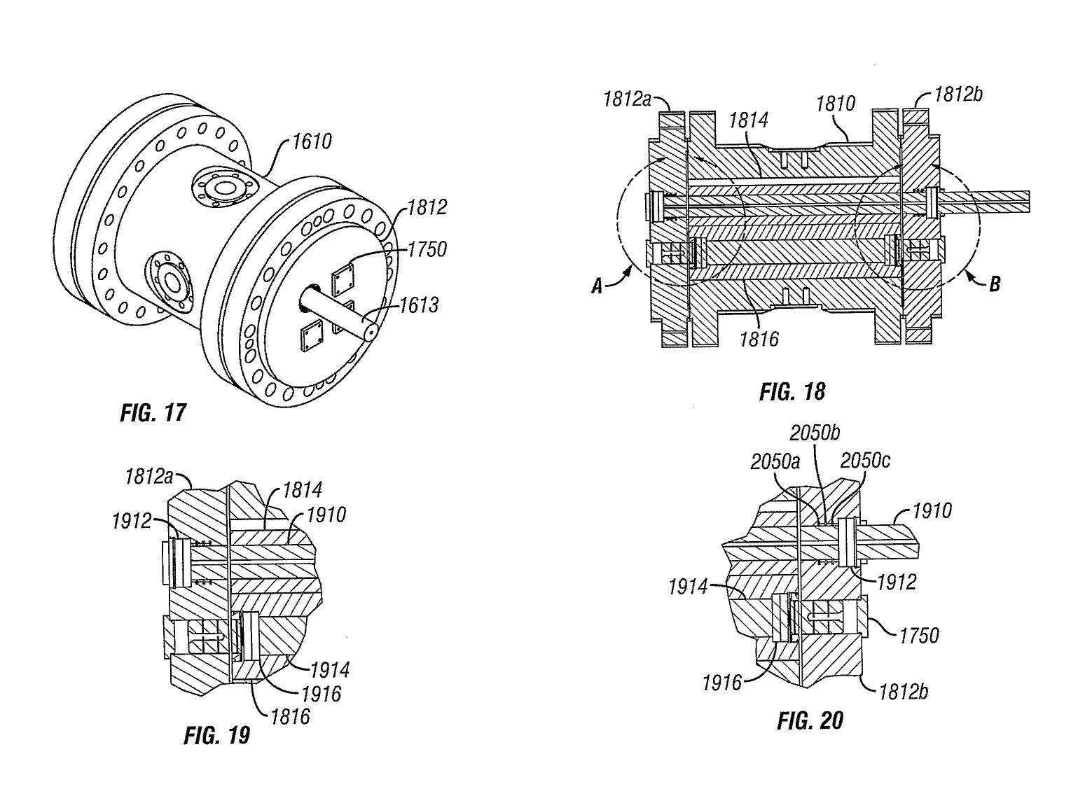

FIG. 17 shows combiner unit 1610 with the end-plate bolts and the input and the output lines removed. FIG. 18 is a cross-section of the combiner unit 1610 of FIG. 17 including a housing 1810 that is sealed by end-plates 1812a and 1810b inside housing 1810. Output rotor 1814 is seen engaged with idle rotor 1816.

FIG. 19 is a detail of area A of FIG. 18 in which output rotor 1814 is again seen engaged with idle rotor 1816, and an output shaft 1910 protrudes from end plate 1812a and is supported by bearings 1912. Likewise, idle shaft 1914 is supported by bearings 1916 that are located within idle rotor 1816.

Referring now to FIG. 20, a detail of area of B of FIG. 18 is seen in which idle shaft 1914 again terminates in end cap 1812b and is supported by bearings 1916. Output shaft 1910 protrudes through end cap 1812b and is supported by bearings 1912. Output shaft 1910 includes o-ring seals 2050a 2050b, and 2050c.

FIG. 21 is a perspective view of an idle shaft (such as shaft 1914 of FIG. 20) that is press-fit (in at least one example) into an idle rotor 1816. Output shafts are also press-fit in some examples. In alternative examples, shafts (whether idle or output shafts) may be integrally formed with a rotor or bound in a slot-key configuration. Other shaft-rotor configurations will occur to those of skill in the art. O-ring seals 2105a and 2105b are seen residing in slots in shaft 1914.

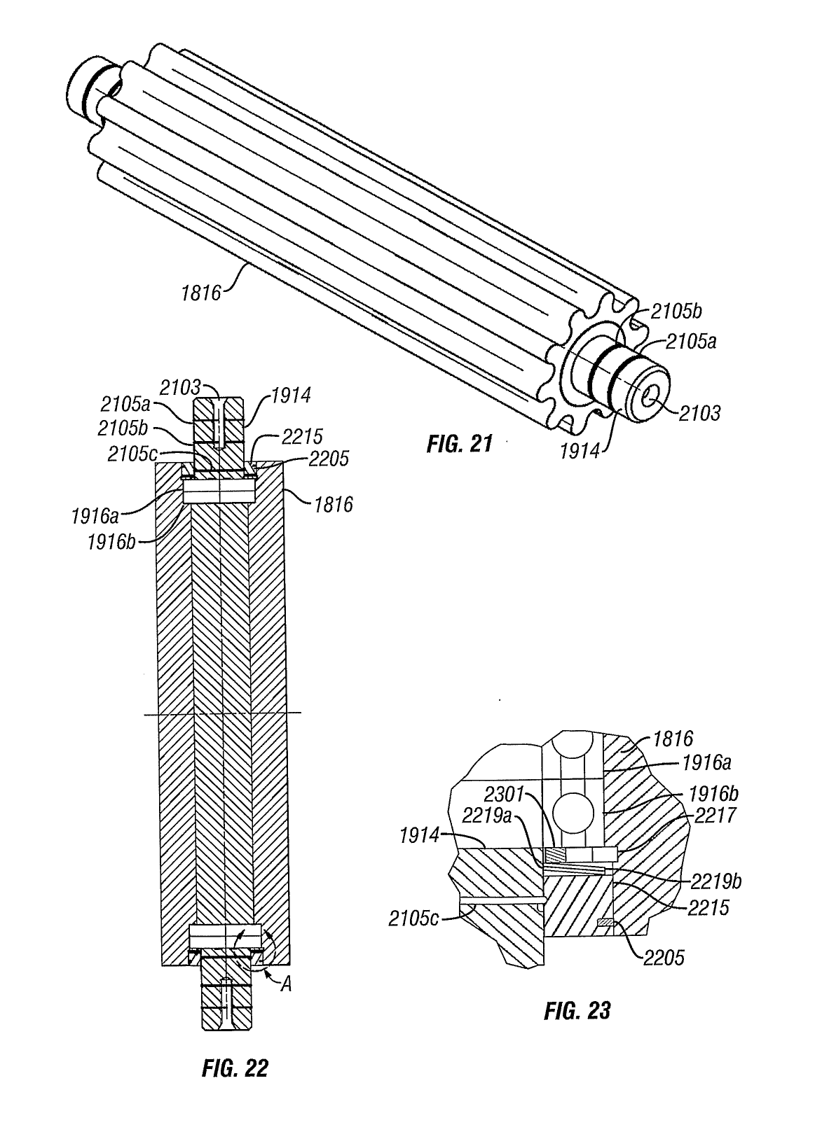

FIG. 22 illustrates a section view of the shaft-rotor assembly of FIG. 21, and a third o-ring seal 2105c is seen within rotor 1816 on shaft 1914. Hole 2103 is for handling shaft 1914 during assembly. Bearings 1916a and 1916b reside at each end of shaft 1914 and rotate with rotor 1816.

FIG. 23 is a detail of area A of FIG. 22. As seen, bearings 1916a and 1916b are held in place by snap ring 2217, which rotates with rotor 1816. Bellville spring washers 2219a and 2219b, which are in contact with ring seal plate 2215, bias the inner diameter of bearing assembly 1916b (in at least one example, an ultra-precision angular contact bearing such as a SKF 571910; angle acdga; (fit p4a) against bearing assembly 1916a (also an ultra-precision angular contact bearing, for example) through spacer ring 2301. Thus, rotor 1816, the outer diameter of bearings 1916a and 1916b, and ring 2217, rotate together. Piston ring 2205 resides in ring seal plate 2215 for the purpose of sealing bearings and grease from possible condensate originating from a fluid (e.g. natural gas) stream. In still another alternative example, rather than ball bearings, magnetic bearings are used. Further example bearings will occur to those of skill in the art.

Referring again to FIG. 20, bearings 1912 are the same type as bearings 1916 (FIG. 19) and are held in end plate 1812b by a snap ring, Belleville washers, and a ring seal plate, similar to the structure seen in FIG. 22. As mentioned previously, in at least one example, shafts 1910 and 1914 are press-fit into their respective rotors. A press-fit functions due to close tolerance of the parts; for example, for a rotor having a 2.25 inch inner diameter, the shaft has, at least in one example, between 2.240 inches and 2.167 inches as an outer diameter.

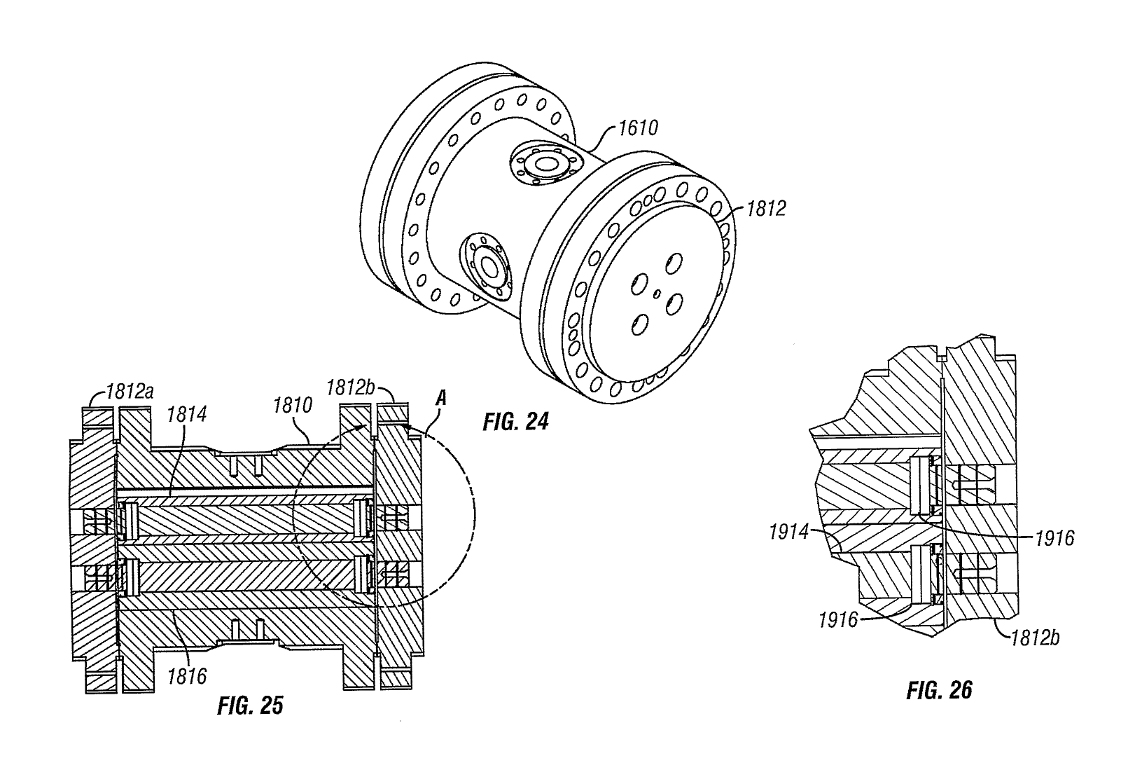

In yet a further example, as seen in FIGS. 24 and 25, still another example combiner unit 1610 is seen in which all shafts comprise idle shafts. FIG. 26 is a detail of area A of FIG. 25 and shows that, in the example of FIGS. 24 and 25, all idle shafts are constructed as in FIG. 19, above. Referring again to FIG. 17, for those shafts that are not output shafts, an end cap 1750 is bolted or screwed into the opening in end plate 1812.

In still further examples, multiple output shafts are used, rather than just one.

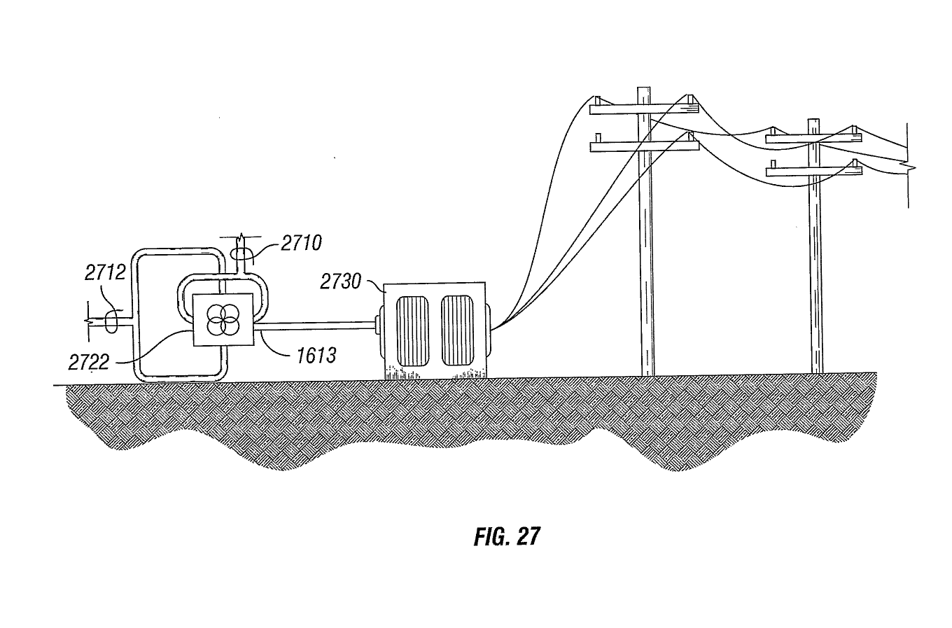

Referring now to FIG. 27, an example embodiment is seen in which a high pressure transmission line 2710 is split into two inputs for a combiner unit 2722 having at least one output shaft 1613 for turning generator 2730. In the illustrated example, generator 2730 is connected to the power grid. In other examples, the output of generator 2730 is used for other purposes.

The above description and the figures have been given by way of example only. Further embodiments of the invention will occur to those of skill in the art without departing from the spirit of the definition of the invention seen in the claims below.

What is claimed is:

1. A method of combining at least two fluid streams of differing pressures,
the method comprising:
receiving, into a first volume, a fluid of a first pressure;
receiving, into a second volume, a fluid of a second pressure; and
combining, in a third volume, a portion of fluid from the first volume with a portion of the fluid from the second volume, due to a pressure differential between the first volume and at least the third volume;
combining, in a fourth volume, a portion of fluid from the first volume with a portion of the fluid from the second volume, and
communicating the third and the fourth volumes into a single flow line.

2. A method as in claim 1 wherein said combining, in a third volume, comprises:
capturing the portion of fluid from the first volume;
capturing the portion of fluid from the second volume;
transporting the captured portion of the first volume to the third volume; and
transporting the captured portion of the second volume to the third volume.

3. A system for combining at least two fluids of differing pressures,
the system comprising:
means for receiving, into a first volume, a fluid of a first pressure;
means for receiving, into a second volume, a fluid of a second pressure; and
means for combining, in a third volume, a portion of fluid from the first volume with a portion of the fluid from the second volume, due to a pressure differential between the first volume and at least the third volume;
means for combining, in a fourth volume, a portion of fluid from the first volume with a portion of the fluid from the second volume, and
means for communicating the third and the fourth volumes into a single flow line.

4. A system as in claim 3 wherein said means for combining, in a third volume, comprises:
means for capturing the portion of fluid from the first volume;
means for capturing the portion of fluid from the second volume;
means for transporting the captured portion of the first volume to the third volume; and
means for transporting the captured portion of the second volume to the third volume.

5. A system as in claim 4, wherein
said means for capturing the portion of fluid from the first volume comprises a plurality of rotor protrusions sealing with a non-rotating member, wherein the sealing occurs in the first volume and a plurality of sealed protrusions defines the captured portion, and
said means for capturing the portion of fluid from the second volume comprises a plurality of rotor protrusions sealing with a non-rotating member, wherein the sealing occurs in the first volume and a plurality of sealed protrusions defines the captured portion.

6. A system as in claim 4 wherein
said means for transporting the captured portion from the first volume comprises means for rotating the rotor protrusions to an unsealed position in the third volume, and
said means for transporting the captured portion from the second volume comprises means for rotating the rotor protrusions to an unsealed position in the fourth volume.

7. A system as in claim 6 wherein said means for rotating comprises a pressure differential between the first volume and the second volume.

8. A system as in claim 3 wherein said means for communicating comprises a first fluid output conduit in communication with the third volume, a second fluid output conduit in communication with the fourth volume, wherein the first and the second output conduits are both in communication with the single flow line.

9. An apparatus useful in combining at least two fluids of differing pressures,
the apparatus comprising:
a housing;
a first rotor within the housing;
a second rotor within the housing, the first rotor engaging the second rotor and both the first and the second rotors engaging the housing;
a third rotor within the housing and engaging the first rotor;
a fourth rotor within the housing and engaging the second rotor, the third rotor engaging the fourth rotor and both the third and the fourth rotors engaging the housing;
wherein the first and the second rotors define a first input volume;
wherein the third and the fourth rotors define a second input volume;
wherein the first and the third rotors define a first output volume; and
wherein the second and the fourth rotors define a second output volume.

10. An apparatus as in claim 9 wherein at least two rotors are in a sealing engagement.

11. An apparatus as in claim 9 wherein the rotors are substantially the same size.

12. An apparatus as in claim 9 wherein a first pair of the rotors is larger than a second pair of the rotors.

13. An apparatus as in claim 9 wherein the rotors are mounted on bearings around fixed shafts.

14. An apparatus as in claim 9 wherein at least one rotor is fixed to the shaft of the rotor.

15. An apparatus as in claim 9 wherein the housing comprises a substantially cylindrical shape having sealing surfaces arranged therein to seal with the rotors.

16. An apparatus as in claim 15 wherein the housing comprises inputs substantially normal to the axis of the housing.

17. An apparatus as in claim 15 wherein the housing comprises inputs substantially parallel to the axis of the housing.

18. A rotor useful in an apparatus for combining at least two fluids of differing pressures, the rotor comprising:
a set of protrusions;
a set of recesses between the protrusions;
wherein the protrusions comprise sealing surfaces;
wherein at least a portion of the sealing surface comprises a portion of a first circle;
wherein the recesses comprise sealing surfaces;
wherein at least a portion of the sealing surface comprises a portion of a second circle;
wherein the first circle and the second circle are tangential;
wherein the first circle and the second circle each have centers located on a circle having a center on an axis of the rotor.

19. A rotor as in claim 18 wherein the rotor forms a substantially cylindrical void.

20. A rotor as in claim 18 wherein the rotor is fixed to a shaft.

21. A rotor as in claim 18 wherein the rotor is rotationally mounted on rotational bearings and the rotational bearings are mounted on a shaft, wherein the rotational bearings allow the rotor to rotate around the shaft.

22. A gas gathering system comprising:
a first input of gas at a first pressure;
a second input of gas at a second pressure, the first pressure being higher than the second pressure;
a means for combining the first and the second inputs of gas;
wherein the means for combining uses pressure differences between the first input of gas and the second input of gas to power the means for combining.

23. A gas gathering system as in claim 18 further comprising a gas/fluid separator receiving gas and fluids from a well;
wherein the first input of gas comprises gas from the separator, and a liquids tank, receiving liquids from the separator, wherein the second input of gas comprises vapor from the tank.

24. A gas gathering system comprising:
a first well;
a first flow line of gas from the first well;
a first separator connected to the first flow line;
a first separated gas flow line connected to a first input of a means for combining at least two gas flows having different pressures;
a second well;
a second flow line of gas from the second well;
a second separation connected to the second flow line;
a second separated gas flow line connected to a second input of the means for combining;
wherein the means for combining comprises a first input volume and a second input volume; and
a pressure differential between the first input volume and the second input volume causes a portion of the first input volume to be combined with a portion of the second input volume at an output volume.

25. An apparatus useful in turning a shaft,
the apparatus comprising:
a housing;
a first rotor within the housing;
a shaft connected to the first rotor and projecting out of the housing;
a second rotor within the housing, the first rotor engaging the second rotor and both the first and the second rotors engaging the housing;
a third rotor within the housing and engaging the second rotor;
a fourth rotor within the housing and engaging the first rotor, the third rotor engaging the fourth rotor and both the third and the fourth rotors engaging the housing;
wherein the first and the second rotors define a first input volume;
wherein the third and the fourth rotors define a second input volume;
wherein the first and the fourth rotors define a first output volume; and
wherein the second and the third rotors define a second output volume.

26. An apparatus as in claim 25 wherein at least two rotors are in a sealing engagement.

27. An apparatus as in claim 25 further comprising rotational bearings between the shaft connected to the first rotor and the housing.

28. An apparatus as in claim 27 wherein the bearings are located in an end plate of the housing.

29. An apparatus as in claim 28 further comprising bearings located between the second rotor and a substantially non-rotating shaft connected to the housing.

30. A method of turning a shaft, the method comprising:
converting a pressure differential across a first rotary member into rotational motion of the first rotary member;
applying the rotational motion to the shaft;
converting a pressure differential across a second rotary member into rotational motion of the second rotary member; and
applying the rotational motion of the second rotary member to the first rotary member.

31. A method as in claim 30, further comprising:
converting a pressure differential across a third rotary member into rotational motion of the third rotary member, and
applying the rotational motion of the third rotary member to the first rotary member.

32. A method as in claim 31, further comprising:
converting a pressure differential across a fourth rotary member into rotational motion of the fourth rotary member, and
applying the rotary motion of the fourth rotary member to the second rotary member.

33. A system for turning a shaft, the system comprising:
means for converting a pressure differential across a first rotary member into rotational motion of the first rotary member;
means for applying the rotational motion to the shaft;
means for converting a pressure differential across a second rotary member into rotational motion of the second rotary member; and
means for applying the rotational motion of the second rotary member to the first rotary member.

34. A system as in claim 33, further comprising:
means for converting a pressure differential across a third rotary member into rotational motion of the third rotary member, and
means for applying the rotational motion of the third rotary member to the first rotary member.

35. A system as in claim 34, further comprising:
means for converting a pressure differential across a fourth rotary member into rotational motion of the fourth rotary member,
means for applying the rotary motion of the fourth rotary member to the second rotary member.

36. A system as in claim 33, wherein said means for converting a pressure differential across the first rotary member comprises a blade separating a first volume at a first pressure from a second volume at a second pressure.

37. A system as in claim 33, wherein said means for applying the rotational motion to the shaft comprises a mechanical connection between the rotary member and the shaft.

38. A system as in claim 37, wherein the shaft rotates substantially coaxially with said first rotational member.

39. A system as in claim 38, wherein the shaft is press-fit in said first rotational members.

40. A system as in claim 38, wherein the shaft is integrally formed with said first rotational member.

41. A system as in claim 38, wherein the shaft is rigidly connected to the rotational member.

42. A system as in claim 33, wherein said means for converting a pressure differential across a second rotary member into rotational motion comprises a blade separating a third volume from a first volume.

43. A system as in claim 42, wherein said means for converting a pressure differential across a second rotary member comprises a blade separating a first volume at a first pressure from a second volume at a second pressure.

44. A system as in claim 34 wherein said means for converting a pressure differential across the third rotary member into rotational motion of the third rotary member comprises a blade separating a fourth volume from the second volume.

45. A system as in claim 35, wherein said means for converting a pressure differential across the fourth rotary member into rotational motion of the fourth rotary member comprises a blade separating the third volume from the fourth volume.

46. A method of reducing pressure in a natural gas line, the system comprising:
receiving natural gas at a first input at an input pressure, whereby there is a pressure differential established across a first rotary member;
converting the pressure differential into rotational motion of the rotary member;
regulating a load on the first rotary member;
passing the gas through rotation of the rotary member to an output,
wherein the regulation of the load on the first rotary member maintains the pressure of the gas at the output between a range of pressures below the input pressure.

47. A method as in claim 46, further comprising:
converting a pressure differential across a second rotary member into rotational motion of the second rotary member, and
applying the rotational motion of the second rotary member to the first rotary member.

48. A method as in claim 47, further comprising:
receiving natural gas at a second input at the input pressure, whereby there is a pressure differential established across a third rotary member;
converting the pressure differential across the third rotary member into rotational motion of the third rotary member, and
applying the rotary motion of the third rotary member to the first rotary member.

49. A method as in claim 48 further comprising:
converting a pressure differential across a fourth rotary member into rotational motion of the fourth rotary member, and
applying the rotational motion of the forth rotary member to the second and the third rotary members.

50. A system of reducing pressure in a natural gas line, the method comprising:
means for receiving natural gas at a first input at an input pressure, whereby there is a pressure differential established across a first rotary member;
means for converting the pressure differential into rotational motion of the rotary member;
means for regulating a load on the first rotary member;
means for passing the gas through rotation of the rotary member to an output,
wherein the regulation of the load on the first rotary member maintains the pressure of the gas at the output between a range of pressures below the input pressure.

51. A system as in claim 50, further comprising:
means for converting a pressure differential across a second rotary member into rotational motion of the second rotary member, and
means for applying the rotational motion of the second rotary member to the first rotary member.

52. A system as in claim 51, further comprising:
means for receiving natural gas at a second input at the input pressure, whereby there is a pressure differential established across a third rotary member;
means for converting the pressure differential across the third rotary member into rotational motion of the third rotary member, and
means for applying the rotary motion of the third rotary member to the first rotary member.

53. A system as in claim 52 further comprising:
means for converting a pressure differential across a fourth rotary member into rotational motion of the fourth rotary member, and
means for applying the rotational motion of the forth rotary member to the second and the third rotary members.

54. A system as in claim 52 wherein said means for receiving natural gas at a second input at the input pressure comprises the pressure housing, the third rotor, and the fourth rotor, wherein the third rotor and the fourth rotor are in meshed contact with each other and in movable sealing contact with the housing to define a second input volume.

55. A system as in claim 52 wherein the means for converting the pressure differential across the third rotary member into rotational motion of the third rotary member comprises protrusions from the rotary member.

56. A system as in claim 52 wherein the means for applying the rotary motion of the third rotary member to the first rotary member comprises protrusions of the third rotary member meshed with protrusions from the first rotary member.

57. A system as in claim 52 further comprising:
means for converting a pressure differential across a fourth rotary member into rotational motion of the fourth rotary member, and
means for applying the rotational motion of the forth rotary member to the second and the third rotary members.

58. A system as in claim 50 wherein the means for receiving natural gas at a first input at a first input pressure comprises a pressure housing having at least two rotors in meshed contact with each other and in movable sealing contact with the housing to define a first input volume.

59. As system as in claim 50 wherein the means for converting the pressure differential into rotational motion of the rotary member comprises protrusions from the rotary member.

60. A system as in claim 50 wherein the means for regulating a load on the first rotary member comprises a generator being mechanically connected to the first rotary member.

61. A system as in claim 50 wherein the means for passing the gas through rotation of the rotary member to an output comprises multiple protrusions trapping gas in the input volume between themselves and the housing and rotating the trapped gas to an output volume.

62. A system as in claim 50, wherein said means for converting a pressure differential across a second rotary member into rotational motion of the second rotary member comprises protrusions from the second rotary member.

63. A system as in claim 50, wherein said means for applying the rotational motion of the second rotary member to the first rotary member comprises protrusions of the first rotary member meshed with protrusions from the second rotary member.
